(19) United States
(12) Patent Application Publication
(10) Pub. No.: US 2020/0282523 A1
(43) Pub. Date: Sep. 10, 2020

(54) Interchangeable Jaw Pliers

(71) Applicant: Nigel Alexander Buchanan, Fife (GB)

(72) Inventor: Nigel Alexander Buchanan, Fife (GB)

(21) Appl. No.: 16/760,680

(22) PCT Filed: Oct. 30, 2018
(86) PCT No.: PCT/GB2018/000140

§ 371 Date: Apr. 30, 2020

(30) Foreign Application Priority Data
Oct. 30, 2017 (GB) 1717864.1

(51) Int. Cl. B25B 7/04; B25B 7/12

(52) U.S. Cl. CPC B25B 7/04; B25B 7/123

(57) ABSTRACT

Interchangeable jaw pliers with detachable jaws that are push fit attachable to respective jaw mountings connected with the pliers handles

### FIELD OF INVENTION

The invention relates to pliers with interchangeable jaws.

### BACKGROUND TO THE INVENTION

Existing locking pliers disclosed by U.S. Pat. No. 9,855,642 (Wu), US2015273664 (Skodje et al) and U.S. Pat. No. 9,855,642 (Wu) comprise two handles connected to respective jaws, and a locking mechanism connected to the two jaws. The handles can be squeezed to close the jaws. A locking member is attached to an over centre linkage, which when utilized prevents the lower handle from pivoting from its closed configuration and until opened retains the jaws in a closed position. The clamping width of the jaws is adjusted by an adjustment screw. The adjustment screw also determines the clamping pressure exerted upon the clamped workpiece. As the clamping pressure has to be pre-set, it can take several attempts to correctly adjust the screw to the position required to clamp the workpiece the optimum way. The clamping width of the jaws once set by the adjusting screw is finite, so any movement, vibration or relaxing of the clamped material will normally result in the failure of the clamping action. This is most prevalent when the pliers are used to initially clamp vehicle bodywork parts during a panel beating process prior to welding or bolting the panels as inadvertent over pressure applied by the clamping jaws usually results in damage or distortion of the clamped parts.

USD742194 (Engel et al) shows pliers having a toothed strut with a locking mechanism attached to one operating arm. As the arms are closed, the teeth ratchet past the lock. As the operating arms are not designed to resiliently deform, the toothed arc of the strut remains in substantially the same locking angle relative to the locking mechanism.

EP2818280(Buchanan) discloses pliers having a bowed or arcuate portion to permit limited flexing of one of the handles. A pivotal strut is retained between the handles. A first end of the strut is slidably held in a channel within one handle and the second end is pivotally held within the other handle. The second end has an arcuate side surface provided with teeth of the strut. The strut acts with a switch and a pawl to lock or unlock the handle positions relative to one another. The compression of the handles closing the gap between the fixed and moveable jaws, the moveable jaw sliding up a clamp bar portion until the jaws robustly contact the workpiece, the further operation of the handles resulting in the clamping of the workpiece, the resilient arcuate portion acting to impose a limited sprung grip upon the workpiece, further usefulness imported by the locking action of the pawl teeth within the strut arc teeth when the pawl is switched into its ratchet locking position retaining the handles substantially in their closed position providing a limited spring grip upon the workpiece. The arc of the toothed strut in conjunction with the corresponding toothed arc of the pawl being capable of compensating for the changes in angles of one handle relative to the other as the resilient portion flexes as differing pressures are applied to the handles during use, the pawl is activated into either a locking or non-locking position by a further separate “rocker” switch incorporating a spring and plunger mechanism which acts upon the pawl.

It is an object of the present invention to at least partially alleviate the above-mentioned disadvantages, or to provide a cost saving alternative to existing products.

### SUMMARY OF THE INVENTION

The invention provides interchangeable jaw pliers as specified in claim 1.

Examples of the invention interchangeable jaw pliers comprising a head portion incorporating gripping faces within the opposing jaws for the clamping of the desired workpiece, pivotal handle portions and a pivotal strut positioned between the handles. Bow shaped resilient portion or portions can be usefully incorporated within either or both the jaw or handle portions, when the pliers are operated these resilient portions impart a useful sprung pressure upon the clamped workpiece by the gripping face of the jaws. The jaws can be usefully locked in the required clamping position upon the workpiece, in this example by a pivotal strut having a first end toothed arc being locked or unlocked according to the toothed switch operation within the first handle and having a strut second end slidingly engaged within a strut channel in the opposing second handle by an axle pin. The said opposing or second handle having a recess or channel with outer slots for the retention of the strut second end axle pin within the said slots, the strut second end is driven down the second handle channel within the confines of the slots as the handles are closed relative to one another, the pivoting first end of the strut the toothed arc, ratcheting against the sprung biased corresponding switch teeth. In order to provide as versatile as possible a set of pliers the jaw portions are interchangeable with other jaw portions the gripping faces can comprise of clamping or gripping profiles useful for many purposes, metalwork, woodwork and automotive to name but a few, whilst the handle portion within its particular size range can be the same incurring a substantial cost and storage saving.

The interchangeable jaw pliers may comprise an intuitive switch locking/unlocking mechanism utilizing less parts than previous pliers type tools comprising pivotal struts with toothed arcs interacting with a switch. The switch usefully now directly incorporates a single piece locking, ratcheting or disengaged teeth mechanism according to its chosen orientation, which can be usefully utilized as required to engage with the teeth of the toothed strut arc to positionally to lock as required the same, thereby locking the clamped workpiece within the jaw portions, or alternately disengaging the switch teeth from the strut toothed arc releasing the workpiece from the jaws, according to the pivotal switch orientation.

The switch may incorporate a ratchet function, the switch usefully incorporating a bore for the engagement of a biasing pin and its compression spring, said biasing pin being free to move lengthwise within said bore against the resilient force of the spring. In best practice the outer end of the biasing pin is rounded or angled with a blunt point for ease of movement against a corresponding peaked engagement profile. Said pin having a close sliding fit within said bore whereas it can easily traverse inwards or outwards against the spring within said bore according to the engagement between the blunt point and the corresponding peaked engagement profile mounted within the handle. Said switch engagement profile further comprising of a transition peak with a sloping open profile on one side and a switch closing profile on the other, the pivotal switch can be manually intuitively operated by the operator from either chosen position, during said switch positional operation said biasing pin is resiliently propelled into the switch bore against the incumbent spring as its outward blunt point moves against the corresponding upwardly sloping engagement profile till it traverses the peak of the engagement profile and consequently now engages the downwardly sloping engagement profile at the other side of the peak, the switch spring usefully resiliently propelling the biasing pin blunt outward end against its corresponding sloping engagement profile positively resiliently engaging or disengaging the switch teeth from the toothed strut arc teeth according to the operators requirements.

As it is commercially prudent to have a ratchet like clicking noise to accompany the jaw closure and locking procedure the interaction of the resiliently biased switch teeth with the corresponding pivotal strut toothed arc teeth, when the switch is in the closed position provides a typical ratchet like sound as the strut rotates during the closure procedure around the strut axle against the resilience of the strut spring.

The interchangeable jaw pliers may provide clamping widths within its specification that are automatically adjusted, the locking pressure can be further be usefully determined by the operator by the straightforward gripping pressure of the handles, the simple release of the handles when the switch is in the closed position initiating the locking if required of the jaws upon the clamped parts. The operator defining the option of the device being in the locking or unlocked mode by the positioning of said switch. The clamping action of said jaws being determined by the remaining resilience of the bowed portions, the elastic potential energy. The resultant jaw resilient closing force is largely proportional to the force applied to the handles and the pivotal dimension ratio between the handles and jaws less any small losses incurred during the switch locking procedure, the fulcrum being the jaw pivot pin.

The invention also includes, in a further iteration in order to provide a more versatile and useful device, a method whereby the jaw working profiles or outer jaw can be interchanged with other outer jaws with differing working profiles in order to provide a cost-effective equivalent to several set of differing pliers required for different jobs. These interchangeable jaws being usefully locked or unlocked from robust engagement within the lower jaws as required, providing one locking handle set capable of use with a cost-effective range of differing jaws as required.

In one example the lower jaws comprising of a laminate like construction in order to provide a low-cost method of retaining the locking swivel pin which comprises a central axle rotatable within a corresponding thickness and bore within the lower jaw inner plate. The locking swivel pin having a further reduced circumference hereafter termed outer axles, largely level in height to the lower jaw outer plates which have corresponding circular cut out profiles such that the said swivel pin is laterally held within the lower jaw by the outer plates whilst capable of rotation within its afforded enclave. The outer end face of the locking swivel pin can usefully incorporate a small lever for the required operator rotation of the said pin. The locking swivel pin outer axles comprising a spherical locking face and a generally flat unlocking face, the spherical locking face can be further appropriately cam shaped in order to increase the locking mechanism proficiency. The locking swivel pin is located partially within the lower jaw interlocking tongue recess, by rotating the locking swivel pin the profile of the locking swivel pin outer axle can be chosen to either present a locking or unlocking face into the tongue recess. The detachable outer jaws having corresponding locking tongues incorporated within their generally planar outer plates, in best practice the tongues are formed in a slow curve to aid their robust engagement within the matching tongue recesses. When the chosen outer jaw tongues are fully inserted within their lower jaw recesses, the lower jaw abutment faces further robustly contact the outer jaw abutment faces. The tongues having suitably positioned indentations for the engagement of the outer axle locking faces when the locking switch axle is appropriately utilized, conversely the locking switch axles can be suitably rotated wherein the unlocking faces of the said switch axle are substantially in line with the profile of the jaw interlocking tongue indentations in order to provide straightforward engagement or withdrawal of the chosen outer jaw from the lower jaw.

The interchangeable jaws pliers may comprise first and second lower jaws having strong permanent magnets fitted such that their magnetic field can suitably act on the metal leading end of the interlocking tongue portions, the said magnets magnetic force robustly locking the detachable jaw or jaws in place within the said lower jaws, in order to remove a detachable jaw the operator requires to open the jaws and forcefully pull the detachable jaw from the interlocking tongue recess. This construction allows the first and second lower jaw portions to be more cost effectively formed in one piece such as an investment casting without the requirement of separate outer cover plates.

In some examples, the said strut second end being in a generally cylindrical form whereas during assembly said strut can be rotated whereby the second end pin can be usefully inserted into the second handle strut channel, rotated until the second end axle pin engages into the strut end retention slots and the assembly continued, this construction allows the second handle to be formed in one piece such as an investment casting without the requirement of second handle outer plates or a separate cover plate.

In some examples, there is no handle bowed resilient portion incorporated, the pliers operation still incorporating interchangeable jaws or being switchable between locking and unlocking of the handles.

### BRIEF DESCRIPTION OF THE DRAWINGS

In order that the invention may be well understood, some examples will be described with reference to the drawings, in which:

FIG. 1 is a perspective view of the interchangeable jaw pliers;

FIG. 2 is a plan view of the interchangeable jaw pliers;

FIG. 3 is an enlargement of the circled portion of FIG. 2;

FIG. 4 is a plan view of the interchangeable jaw pliers with a part shown in section;

FIG. 5 is an enlargement of the sectioned part of FIG. 4;

FIG. 6 is a view corresponding to FIG. 5 showing an alternative position;

FIG. 7 is a perspective view of the interchangeable jaw pliers showing a workpiece clamped by the pliers;

FIG. 8 is an exploded perspective view of the interchangeable jaw pliers;

FIG. 9 is an exploded perspective view of a detachable jaw of the interchangeable jaw pliers;

FIG. 10 shows a handle and pivotal strut of the interchangeable jaw pliers; and

FIG. 11 is a perspective view of another interchangeable jaw pliers.

### DETAILED DESCRIPTION

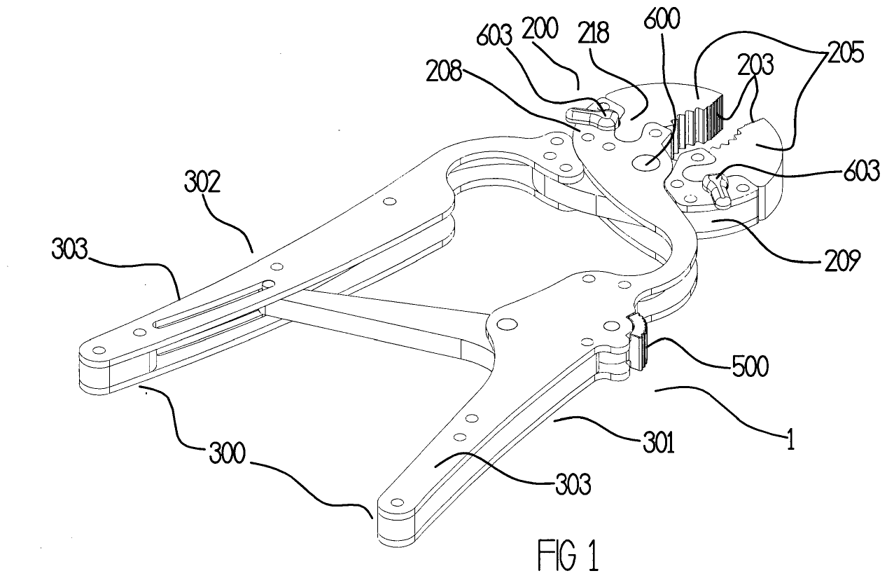

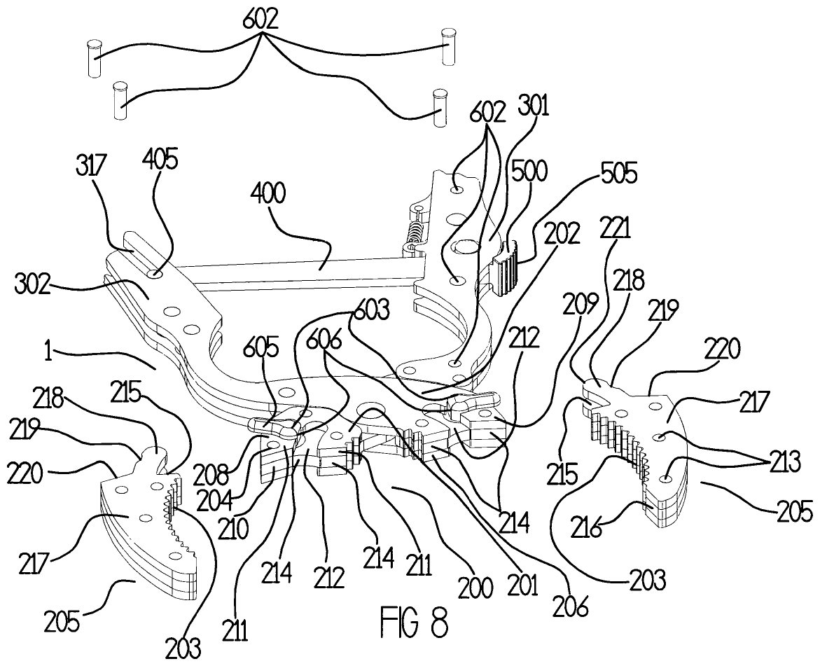

FIG. 1 shows interchangeable jaw pliers 1 at rest. The interchangeable jaw pliers 1 comprises a head portion 200 and a handle portion 300. The handle portion 300 comprises a first handle 301 and a second handle 302 and respective first and second jaw mountings 208. 209 at one end. The head portion 200 comprises detachable jaws 205 that have respective tongue portions 218. The jaw mountings 208, 209 may be provided with respective jaw locking switches 603. A jaw pivot pin 600 may be provided to permit relative pivoting movement of the first and second handles 301, 202. The first and second handles 301, 302 may comprise a laminate structure. For example, the first handle 301 may comprise top and bottom plates 309 (FIG. 7) that define the outer major faces of the handle. Similarly, the second handle 302 may comprise top and bottom plates 311 (FIG. 7) that define the outer major faces of the handle.

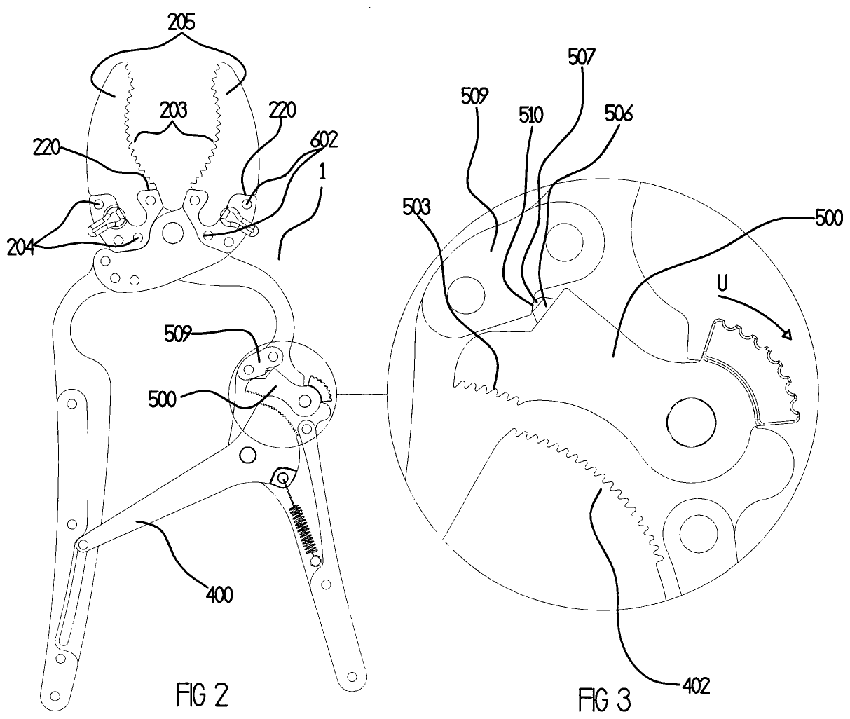

FIG. 2 shows the interchangeable jaw pliers 1 with the top plates 309, 314 removed from the first and second handles 301, 302 to illustrate a pivotal strut 400, a pivotal switch 500 and switch cam block 509. The pivotal switch 500 is shown in a disengaged position. The detachable jaws 205 are shown comprising gripping faces 203 and abutment faces 220. The first and second jaw mountings are shown provided with assembly holes 204 and fixings 602.

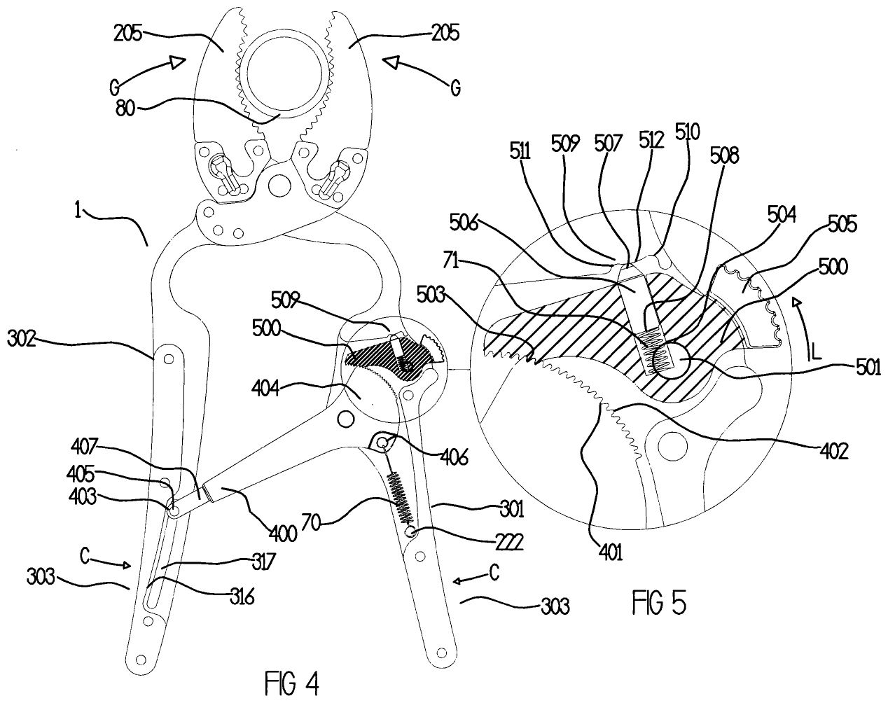

FIG. 3 shows the pivotal switch 500 in its unlocked position. In this position, the actuating end 507 of the switch biasing pin 506 is engaged with an open profile 510 of the switch cam block 509 ensuring that the switch locking teeth 503 provided on the pivotal switch 500 are disengaged from the strut teeth 402.

FIGS. 4 and 5 show the interchangeable jaw pliers 1 with the top plates 309, 314 of the first and second handles 301, 302 removed to illustrate the pivotal strut 400, pivotal switch 500 and switch cam block 509. The pivotal switch 500 is shown in section to illustrate a switched locking mechanism, which can be operated to cause the switch locking teeth 503 to engage the strut teeth 402. <The strut teeth 402 may be provided on an arcuate side, or edge, surface 401 of the pivotal strut 400> to positionally lock a clamped workpiece 80 between the detachable jaws 205. The pivotal switch 500 can also be operated to cause the switch locking teeth 503 from the strut teeth 402 to release the workpiece 80 from the detachable jaws 205. FIG. 4 indicates a clenching force C applied to the handle gripping portions 303 to squeeze the first and second handles 301, 302 to cause the workpiece 80 to be clamped between the detachable jaws 205. An axle 405 is held within the retention slots 317 with a further strut end contact surface 316 available. The first and second handles 301, 302 when operated to move the detachable jaws 205 together act against a spring 70 connected between a spring attachment hole 406 and a spring attachment portion 222 provided on the first handle 301. The spring 70 acts to bias the first and second handles 301, 302 towards an open position when the pivotal switch 500 is in an unlocked position. The switch spring 71 biases the biasing pin 506 so that the actuating end 507 of the biasing spring 56 is pressed against the closing profile 511 of the switch cam block 509 as the handle portion 300 is operated to clamp the workpiece 80. The resiliently biased biasing pin 506 acts to provide a ratchet action between the switch locking teeth 503 and the strut teeth 402 as the pivotal strut 400 is pivoted by its second end 403 interacting with the handle strut end contact surface 316. The pivotal strut 400 is retained by the strut second end axle 405 within the retention slots 317. The strut teeth 402 and the switch locking teeth 503 may have a saw tooth configuration, or profile, to provide an extra safety locking feature, whereby the pivotal switch 500 when moved to an unlocked position still requires the clenching, or squeezing together, of the first and second handles 301, 302 to disengage the switch locking teeth 503 from the strut teeth 402 to release the gripping force applied to the workpiece 80.

FIG. 5 shows the pivotal switch 500 in its locked position. The switch biasing pin 506 actuating end 507 is shown engaged with the closing profile 511 on the switch cam block 509 to ensure that the switch locking teeth 503 are pushed towards, or into, the strut teeth 402 on the pivotal struct 400. Further illustrated are the pivotal switch axle 501, biasing pin bore 504, actuator 505, biasing pin 506, biasing pin actuating end 507, biasing pin spring abutment face 508, switch spring 71, open profile 510 and cam block transition profile 512 of an engagement profile 510, 511, 512 provided on the switch cam block 509.

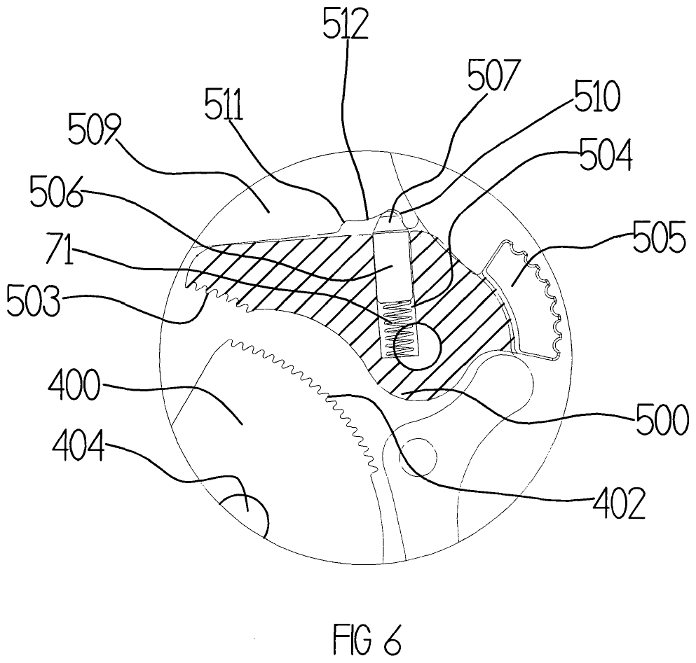

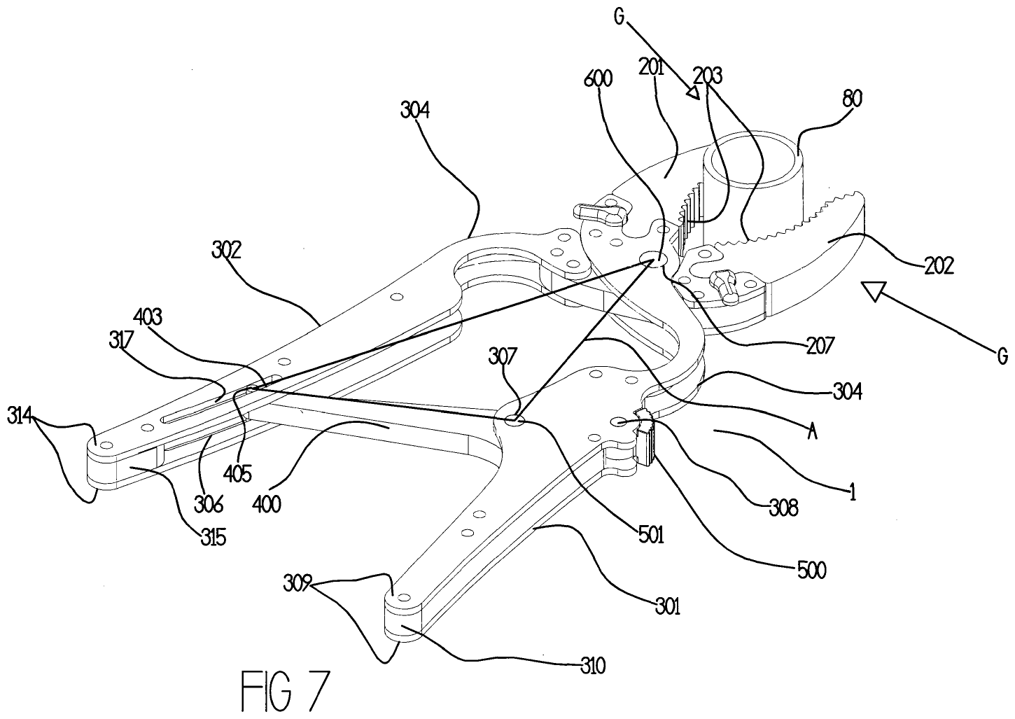

As shown in FIG. 6 the pivotal switch 500 may incorporate ratchet functionality. The pivotal switch 500 has a bore 504 that houses a biasing pin 506 and a biasing compression spring 71. The biasing pin 506 is free to move in a lengthwise direction of the bore 504 against the resilient force of the spring 71. The actuating end 507 of the biasing pin 506 is rounded or angled with a blunt point for ease of movement against a peaked engagement profile 510, 511, 512. The biasing pin 506 is a close sliding fit within the bore 504, which is configured to allow the biasing pin 506 to easily move back and forth in the bore 504 according to the engagement between the actuating end 507 and the engagement profile 510, 511, 512. The engagement profile 510, 511, 512 is defined by a cam surface of the switch cam block 509, which may define a recess in a side of the switch cam block. The engagement profile comprises a transition peak 512 with a sloping open profile 510 on one side and a switch closing profile 511 on the other. The pivotal switch 500 can be manually moved using the switch actuator 505. During operation of the pivotal switch 500, the biasing pin 506 is pushed into the switch bore 504 against the compression spring 71 as the actuating end 507 moves against the corresponding upwardly sloping engagement profile 510, 511 till it traverses the peak of the engagement profile 512 and consequently now engages the chosen downwardly sloping engagement profile at the other side of the peak 510, 511. The switch spring 71 resiliently biases the actuating end 507 against the engagement profile 510, 511 to positively resiliently hold the switch locking teeth 503 in respective positions in which the switch locking teeth 503 are engaged with or disengaged from the strut teeth 502.

The switch spring 71 is further utilized to directly cause the switch teeth 503 to act in a ratcheting manner against the strut teeth 402 when the switch 500 is operated in the locked position and the pivotal strut 400 is pivoted around the strut axle 405 as the handles 301, 302 are clenched.

The switch cam block 509 may be incorporated into a handle spacer 305 or handle 301, 302 assembly.

FIG. 7 illustrates the interchangeable jaws 1 with the gripping faces 203 of the detachable jaws 205 clamped G upon a workpiece 80. Handle bend promoting portions 304 providing resilient gripping G of the detachable jaws 205 on the workpiece 80 when a clenching, or squeezing, force applied to the handles 301, 302 is released. The gripping force is maintained by the engagement of the switch locking teeth with the strut teeth 402. As indicated in FIG. 7, the locked pivotal strut 400 comprises the base and the bend promoting portions 304 comprise the sides of triangular elastic potential energy structure A. The jaw pivot pin 600 forms the apex of the triangle, with the pivotal switch axle 501 forming another corner. The axle 405 at the second end 403 of the pivotal strut 400 acts via the detachable jaws 205 to apply clamping pressure upon the workpiece 80, this clamping force G being advantageously resilient in nature. Further illustrated are the second handle strut channel 306, strut pivot pin hole 307, switch pivot pin hole 308, first handle outer and inner plates 309, 310, second handle outer and inner plates 314, 315.

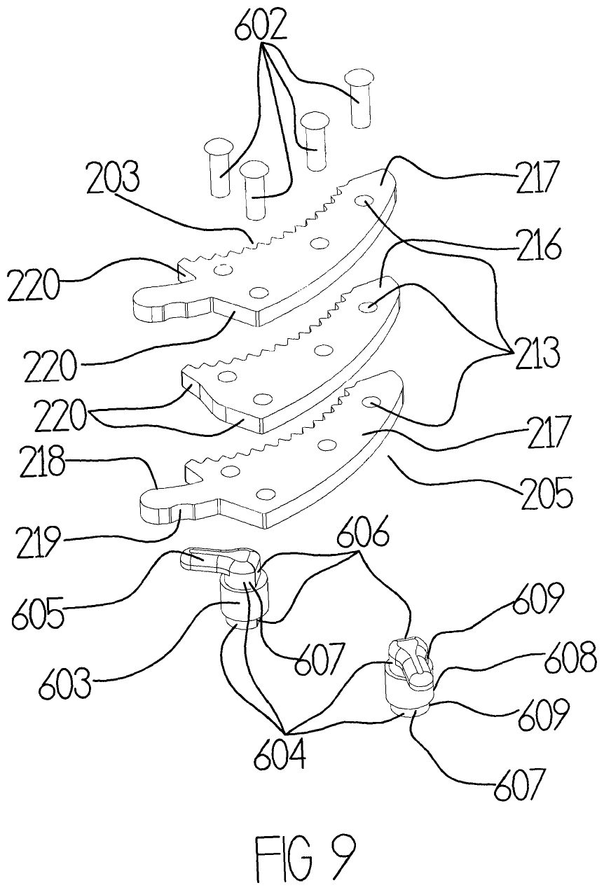

FIG. 8 illustrates the Replaceable jaw pliers 1 head portion 200 first 201 and second 202 jaw portions, with one version of detachable jaw 205 shown disengaged, comprising gripping faces 203, first lower jaw 208, second lower jaw 209, inner plate 210, said outer plate 211, lower jaw web 212, detachable jaw 205, interlocking tongue 218, interlocking tongue indentations 219, abutment faces 220, lower jaw abutment faces 214, detachable jaw engagement slots 215, detachable jaw outer plate 217 and inner plate 216. Jaw locking switch 603, operating lever 605 and jaw switch unlocking face 606. The pivotal strut 400, second end axle 405 is further shown within the strut end retention slot 317, the pivotal switch 500 actuator 505 is illustrated within the first handle portion 301. In this laminated example the handles 301, 302 and said lower and detachable jaws 205 are held together by fixings 602 through assembly holes 204, 213, 306.

FIG. 9 shows an example of a laminated detachable jaw 205 in a dismantled condition. The detachable jaws 205 comprise outer plates 217, inner plate 216, gripping faces 203, blade members that form the tongue portions 218, with indentations 219, abutment faces 220 and fixing holes 213 for fixings 602. Also shown in FIG. 9 are a pair of jaw locking switches 603. Each locking switch 603 comprises a locking switch axle 604, outer retaining axles 608, 609, switch locking face 607, switch unlocking face 606 and a switch operating lever 605.

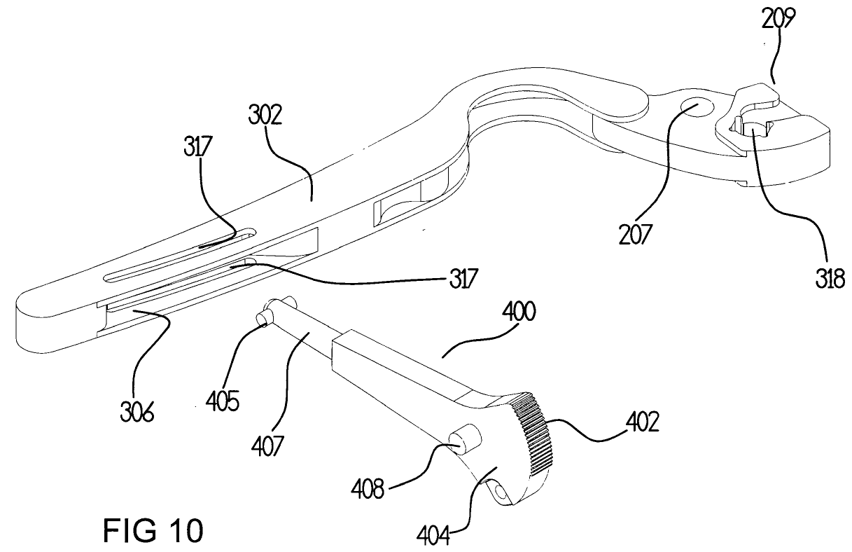

FIG. 10 illustrates a non-laminate second handle 302 comprising a second handle strut channel 306, retention slots 317 for the second end of the pivotal strut 400 and second jaw mounting 209 made in one piece. The second end 403 of the pivotal strut 400 may have a generally cylindrical form 407. During assembly, the pivotal strut 400 can be rotated so that the second end axle pin 405 is in a first condition so that it can be inserted into the second handle strut channel 306 and then rotated until the second end axle pin 405 engages in the retention slots 317. This construction allows the second handle 302 to be formed in one piece such as an investment casting without the requirement of second handle outer plates 314 or a separate cover plate.

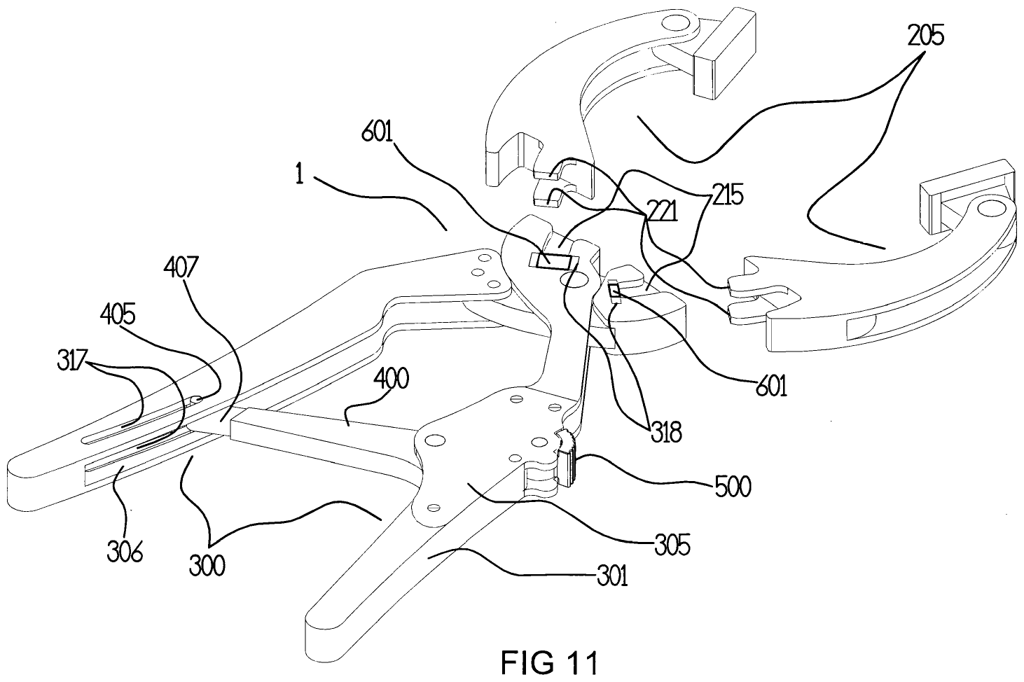

FIG. 11 illustrates another example of an interchangeable jaws pliers 1. The handle portion 300 includes no bend promoting portions such as the bend promoting portions 304 shown in FIG. 7. The interchangeable jaw pliers 1 may comprise a set of woodwork clamping detachable jaws 205, which are shown detached from the handle portion 300. The first and second jaw mountings 208, 209 may be provided with magnet holding slots 318 that at least partially house respective jaw retaining permanent magnets 601. At least the leading edges 221 of the tongue portions 218 of the detachable jaws 205 may be made of a ferrous material so that when the detachable jaws 205 are push-fit engaged with the first and second jaw mountings 208, 209, the detachable jaws 205 are secured to the handle portion 300 by magnetic forces. The handles 301, 302 have first and second jaw mountings 208, 209 that can be manufactured more cost effectively in fewer pieces by, for example, investment casting. Optionally, the second end 403 of the pivotal strut 400 may have a cylindrical section 407. The cylindrical section 407 may be inserted into the second handle strut channel 306 with the strut second end axle 405 extending in the lengthwise direction of the strut channel 306 and then rotated to engage the axle 405 in the retention slots 317. The first handle 301 preferably uses a switch cover plate 305 fixed by known means as an aid to assembly or servicing.

1. Interchangeable jaw pliers comprising a first handle, a first detachable jaw attached to a first jaw mounting disposed at a first end of the first handle, a second handle pivotally connected to the first handle to permit relative pivotal movement of said first and second handles and a second detachable jaw attached to a second jaw mounting disposed at a first end of said second handle, wherein said detachable jaws are push-fit attachable to the respective jaw mounting.

2. Interchangeable jaw pliers as claimed in claim 1, wherein said detachable jaws comprise an inner end provided with a tongue portion configured to push-fit attach to respective mating tongue receiving recesses of the first and second mountings.

3. Interchangeable jaw pliers as claimed in claim 2, wherein said tongue portions comprise opposed blade members that are spaced apart to define a gap, and the tongue receiving recesses are provided with a blade that is push-fit engageable in the respective gap.

4. Interchangeable jaw pliers as claimed in claim 3, wherein said tongue portions and tongue receiving recesses each have a length and curve along said length such that said tongue portions are disposed in converging relationship when said tongue portions are fitted in said tongue receiving recesses.

5. Interchangeable jaw pliers as claimed in any one of the preceding claims, wherein the first and second jaw mountings are provided with respective permanent magnets and at least the leading ends of said tongue portions are made of a ferrous material, whereby said detachable jaws are magnetically securable to said first and second jaw mountings.

6. Interchangeable jaw pliers as claimed in any one of the preceding claims, further comprising respective rotatable switches to lock said detachable jaws to said first and second jaw mountings.

7. Interchangeable jaw pliers as claimed in claim 2, 3 or 4, further comprising respective rotatable switches to lock said detachable jaws to said first and second jaw mountings, wherein said tongue portions are provided with indentations engageable by said rotatable switches to lock the respective detachable jaw to said first and second jaw mountings.

8. Interchangeable jaw pliers as claimed in any one of the preceding claims, further comprising:
a pivotal strut having a first end provided with teeth and a second end pivotally attached to said second handle;
a locking switch pivotally attached to said first handle; and
a biasing pin carried by said locking switch and biased to engage a switch cam block carried by said first handle,
wherein said locking switch has at least one tooth engageable with said teeth provided on said pivotal strut and said switch cam block defines an engagement condition for said biasing pin that allows said locking switch to pivot to allow said at least one tooth to ratchet over said teeth provided on said pivotal strut.

9. Interchangeable Jaw Pliers as claimed claim 8, wherein said locking switch comprises a bore housing said biasing pin and a compression spring that biases said biasing pin towards said switch cam block, said biasing pin being free to move lengthwise within said bore against the compression spring to engage a cam surface on said switch cam block, said cam surface comprising of a transition profile with an open profile at a first side of said transition profile and a closing profile at a second side of said transition profile.

10. Interchangeable jaw pliers as claimed in any one of claims 1 to 7, wherein said detachable jaws are lockable in a clamping position upon the workpiece by a pivotal strut having a toothed first end engageable by teeth provided on a spring biased pivotable locking switch mounted on the first handle and a second end slidingly engaged with at least one slot provided on said second handle, the arrangement being such that when said first and second handles are squeezed towards one another, the second end of the pivotal strut moves along said at least one slot in a direction away from said detachable jaws and the teeth on the first end of the pivotal strut ratchet against teeth provided on the locking switch.

11. Interchangeable Jaw Pliers as claimed in claim 10, wherein said second end of said pivotal strut comprises a generally cylindrical section provided with a pin to engage said at least one slot whereby during assembly said pin can be inserted in a recess provided in said second handle in a first orientation and rotated to a second orientation to engage said at least one slot.

12. Interchangeable jaw pliers as claimed in any one of the preceding claims, comprising clamping widths within its specification that are automatically adjusted, the locking pressure can be further be usefully determined by the operator by the straightforward gripping pressure of the handles, the simple release of the handles when the switch is in the closed position initiating the locking if required of the jaws upon the clamped parts, the operator defining the option of the device being in the locking or unlocked mode by the positioning of the said switch.

13. Interchangeable jaw pliers as claimed in claim 10 or 11, further comprising a spring connected between said pivotal strut and first handle to provide resilient opening of said detachable jaws when said locking switch is moved to an unlocking position.

14. Interchangeable jaw pliers as claimed in any one of the preceding claims, wherein at least one of said first and second handles comprises a bowed resilient portion configured to permit bowing of the respective handle when, in use, said detachable jaws are forced against a workpiece by squeezing said first and second handles together.

15. Interchangeable jaw pliers as claimed in any one of the preceding claims, comprising a plurality of sets of said detachable jaws.
